(19) United States
(12) Patent Application Publication
(10) Pub. No.: US 2009/0264071 A1
(43) Pub. Date: Oct. 22, 2009

(54) MULTIFUNCTIONAL PORTABLE ELECTRONIC DEVICE

(75) Inventor: XIAO-KUN WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/190,670

(22) Filed: Aug. 13, 2008

(30) Foreign Application Priority Data
Apr. 18, 2008 (CN) 200810301203.9

(51) Int. Cl. H04B 7/00

(52) U.S. Cl. 455/41.2

(57) ABSTRACT

The invention discloses a multifunctional portable electronic device (100) which includes a main body (10) and a remote controller (20). The main body (10) includes a receiving module (11) and a warning module (13) electro-connecting with the receiving module (11). The receiving module (11) is electronically connected within the main body (10) which is used to receive the signals sent out by the remote controller (20) to drive the warning module (13) to make warning noises.

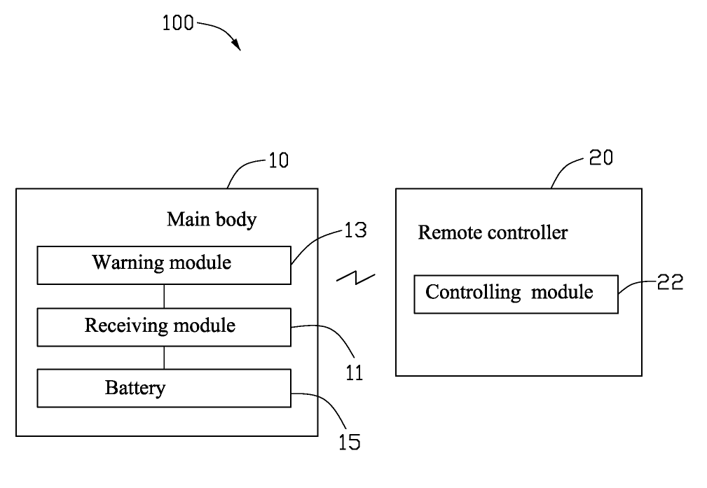

### BACKGROUND

1. Technical Field

The present invention generally relates to multifunctional portable electronic devices, particularly to a multifunctional portable electronic device with an anti-theft function.

2. Discussion of the Related Art

With the development of wireless communication and information processing technology, portable electronic devices such as mobile phones and personal digital assistants (PDAs) are now in widespread use. Consumers may now enjoy the full convenience of high technology products almost anytime and anywhere. Because of the small size of the portable electronic device, when used outdoors, they may be lost or stolen. Normally, owners of lost devices try borrowing a portable electronic device from surrounding strangers to try to communicate with their lost device. However, when the device is stolen (as opposed to lost), thieves can turn off the device or detach the battery from the device to prevent communication with the stolen device. As a result, it is difficult to locate and communicate with a lost or stolen device.

Therefore, there is room for improvement within the art.

### BRIEF DESCRIPTION OF THE DRAWING

Many aspects of the present multifunctional portable electronic device can be better understood with reference to the drawing. The components in the drawings are not necessarily drawn to scale, the emphasis instead being placed upon clearly illustrating the principles of the present multifunctional portable electronic device.

The drawing shows a block diagram of a multifunctional portable electronic device, according to an exemplary embodiment of the present invention.

### DETAILED DESCRIPTION OF THE EMBODIMENT

Referring to the drawing, a block diagram of a multifunctional portable electronic device 100, according to an exemplary embodiment is shown. The multifunctional portable electronic device 100 includes a main body 10 and a remote controller 20 (both shown in “block form”). The main body 10 can be a mobile phone, a personal digital assistant (PDA), etc. The main body 10 includes a receiving module 11, a warning module 13 and a battery 15. The receiving module 11, which includes an antenna, is assembled within the main body 10 and electronically connected with the battery 1 5. The receiving module 11 receives control signals sent by the remote controller 20 to signal the warning module 13 to make warning noises. The battery 15 supplies power to the receiving module 11 and the warning module 13.

The remote controller 20 includes a controlling module 22 corresponding to the receiving module 11. The controlling module 22 can send the control signal to the receiving module 11 to control the main body 10.

In using the multifunctional portable electronic device 100, if the main body 10 is stolen, lost, misplaced or not carried with the user, the user can use the remote controller 20 to send a control signal to the receiving module 11, even if the main body 10 is turned off. After receiving the control signal, sent by the controlling module 22, the receiving module 11 signals the warning module 13 to make warning noises assisting the user in locating the main body 10.

It is to be understood that, the battery 15 could be a detachable battery or a fixed permanent battery of the main body 10 to supply power to the receiving module 11 and the warning module 13, even when the main body 10 is in off mode.

It is also to be understood that, for the special signal to be sent by the controlling module 22, entering a code may be required. Code entry can avoid accidentally activating the warning module 13.

It is also understood that the warning module 13 could include a loudhailer/microphone assembled within the main body 10.

It is also understood that the remote controller 20 could be manufactured as a decorative object, such as a cartoon product, ring, key buckle, etc.

It is also understood that the receiving module 11 could be a short range wireless communication module such as a near field communication (NFC) module, a bluetooth module and the like. Meanwhile, the controlling module 22 of the remote controller 20 can be a short range wireless communication module corresponding to the receiving module 11.

Finally, it is to be understood, however, that even though numerous characteristics and advantages of the present invention have been set forth in the foregoing description, together with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. A multifunctional portable electronic device, comprising:
a main body comprising:
a receiving module assembled within the main body; and
a warning module electronically connected with the receiving module and controlled by the receiving module to make warning sounds; and
a remote controller, the remote controllers used to send a control signal to the receiving module to signal the warning module to make warning sounds.

2. The multifunctional portable electronic device as claimed in claim 1, wherein the remote controller includes a controlling module corresponding to the receiving module assembled within the main body, the controlling module used to send out a special signal to the receiving module.

3. The multifunctional portable electronic device as claimed in claim 2 further comprising a battery, wherein the battery electronically connected with the receiving module to supply power to the receiving and warning modules.

4. The multifunctional portable electronic device as claimed in claim 3, wherein the receiving module includes a short range wireless communication module, and the controlling module of the remote controller is a short range wireless communication module corresponding to the receiving module.

5. The multifunctional portable electronic device as claimed in claim 4, wherein the short range wireless communication module is a near field communication module or a bluetooth module.

6. The multifunctional portable electronic device as claimed in claim 3, wherein the battery is a detachable or permanent battery to supply power to the receiving and warning modules.

7. The multifunctional portable electronic device as claimed in claim 2, wherein the special signal sent out by the controlling module requires entry of a code set by the user to avoid the accidental/wrong operation of the remote controller to the main body as to drive the warning module to make warning noises by accident.

8. The multifunctional portable electronic device as claimed in claim 3, wherein the warning module includes a loudhailer/microphone assembled within the main body.

9. The multifunctional portable electronic device as claimed in claim 3, wherein the remote controller is manufactured as a decorative object.

10. The multifunctional portable electronic device as claimed in claim 9, wherein the decorative object is a cartoon product, ring, or key buckle.

11. The multifunctional portable electronic device as claimed in claim 3, wherein the receiving module includes an antenna module assembled within the main body.

12. The multifunctional portable electronic device as claimed in claim 3, wherein the main body is a mobile phone or a personal digital assistant.
